(19) United States
(12) Patent Application Publication
(10) Pub. No.: US 2008/0079179 A1
(43) Pub. Date: Apr. 3, 2008

(54) Turbulence induced steam dispersion apparatus

(76) Inventors: James Michael Lundgreen, Lakeville, MN (US); Joseph T. Haag, Delano, MN (US); David Nicholas Schwaller, Crystal, MN (US)

Correspondence Address: MERCHANT & GOULD PC, P.O. BOX 2903, MINNEAPOLIS, MN, 55402-0903, US

(21) Appl. No.: 11/895,638

(22) Filed: Aug. 24, 2007

Related U.S. Application Data
(60) Provisional application No. 60/823,575, filed on Aug. 25, 2006.

(51) Int. Cl. B01F 3/02; B01F 5/06; B05B 1/34; B01F 3/04

(52) U.S. Cl. 261/79.2; 239/7; 239/9; 261/116; 261/118; 261/78.2

(57) ABSTRACT

A steam dispersion apparatus configured to humidify a flow of air passing by the steam dispersion apparatus includes a steam dispersion tube configured to emit water in a vapor phase. The steam dispersion tube includes a longitudinal axis extending generally parallel to the direction of the air flow passing by the steam dispersion apparatus. The steam dispersion tube includes a steam exit. A turbulence inducing structure is located upstream of the steam dispersion tube with respect to the air flow, the turbulence inducing structure being configured to increase a velocity of the air that passes through the turbulence inducing structure.

### CROSS-REFERENCE TO RELATED APPLICATIONS

This application claims the benefit of U.S. Provisional Application No. 60/823,575, filed on Aug. 25, 2006, which application is incorporated herein by reference.

### TECHNICAL FIELD

The principles disclosed herein relate generally to the field of steam dispersion humidification. More particularly, the disclosure relates to a steam dispersion apparatus that uses air turbulence to mix steam into moving air.

### BACKGROUND

In the humidification process, steam is normally discharged from a steam source as a dry gas or vapor. As steam mixes with cooler duct air, some condensation takes place in the form of water particles. Within a certain distance, the water particles are absorbed by the air stream within the duct. The distance wherein water particles are completely absorbed by the air stream is called absorption distance. Another term that may be used is a non-wetting distance. This is the distance wherein water particles or droplets no longer form on duct equipment (except high efficiency air filters, e.g.). Past the non-wetting distance, visible wisps of steam (water droplets) may still be visible, for example, saturating high efficiency air filters. However, other structures will not become wet past this distance. Absorption distance is typically longer than the non-wetting distance and occurs when visible wisps have all disappeared and the water vapor passes through high efficiency filters without wetting them. Before the water particles are absorbed into the air within the non-wetting distance and ultimately the absorption distance, the water particles collecting on duct equipment may adversely affect the life of such equipment. Thus, a short non-wetting or absorption distance is desirable.

Some of the current steam dispersion humidification designs use closely spaced tubes with hundreds, even thousands, of nozzles to achieve a short non-wetting or absorption distance. Such designs undesirably heat the duct air and create significant amounts of unwanted condensate. An increased number of tubes and/or nozzles also adds significant cost and weight to the duct systems. However, if the number of tubes and/or nozzles is decreased, although the heat gain and condensate is reduced significantly, the non-wetting and absorption distances are increased dramatically.

What is needed in the art is a steam dispersion apparatus that will lead to both short non-wetting and absorption distances and minimal heat gain and condensation.

### SUMMARY

The principles disclosed herein relate to an apparatus that uses air turbulence to efficiently mix steam with moving air.

In one particular aspect, the disclosure is directed to a turbulence inducing steam dispersion apparatus that uses blades, vanes, baffles or other turbulence-inducing structures to create air turbulence and to disperse discharged steam into the moving air within a short distance.

In another particular aspect, the disclosure is directed to a steam dispersion apparatus that includes a steam tube with steam discharge nozzles located at a downstream end of the turbulence-inducing structure.

A variety of additional inventive aspects will be set forth in the description that follows. The inventive aspects can relate to individual features and combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is a perspective view of a steam dispersion apparatus having features that are examples of inventive aspects in accordance with the principles of the present disclosure, the steam dispersion apparatus shown mounted within an air duct, the air duct shown with a portion thereof broken away to expose the steam dispersion apparatus therein;

FIG. 2 is a perspective view of the steam dispersion apparatus of FIG. 1;

FIG. 3 is a right side view of the steam dispersion apparatus of FIG. 2;

FIG. 4 is a front view of the steam dispersion apparatus of FIG. 2; and

FIG. 5 illustrates another embodiment of a steam dispersion apparatus having features that are examples of inventive aspects in accordance with the principles of the present disclosure;

FIG. 6 illustrates yet another embodiment of a steam dispersion apparatus having features that are examples of inventive aspects in accordance with the principles of the present disclosure;

FIG. 7 illustrates yet another embodiment of a steam dispersion apparatus having features that are examples of inventive aspects in accordance with the principles of the present disclosure; and

FIG. 8 illustrates yet another embodiment of a steam dispersion apparatus having features that are examples of inventive aspects in accordance with the principles of the present disclosure.

### DETAILED DESCRIPTION

The principles disclosed herein relate generally to the field of steam dispersion humidification. In one particular aspect, the disclosure is directed to a steam dispersion apparatus that uses blades, vanes, baffles, or other turbulence-inducing structures to induce air turbulence and to disperse discharged steam into the moving air within a short distance.

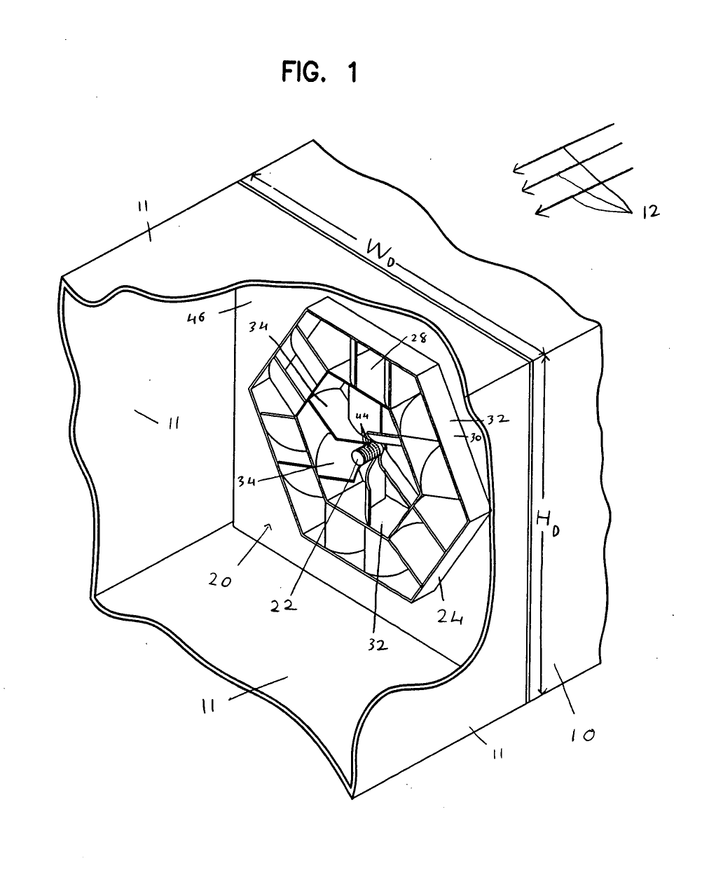

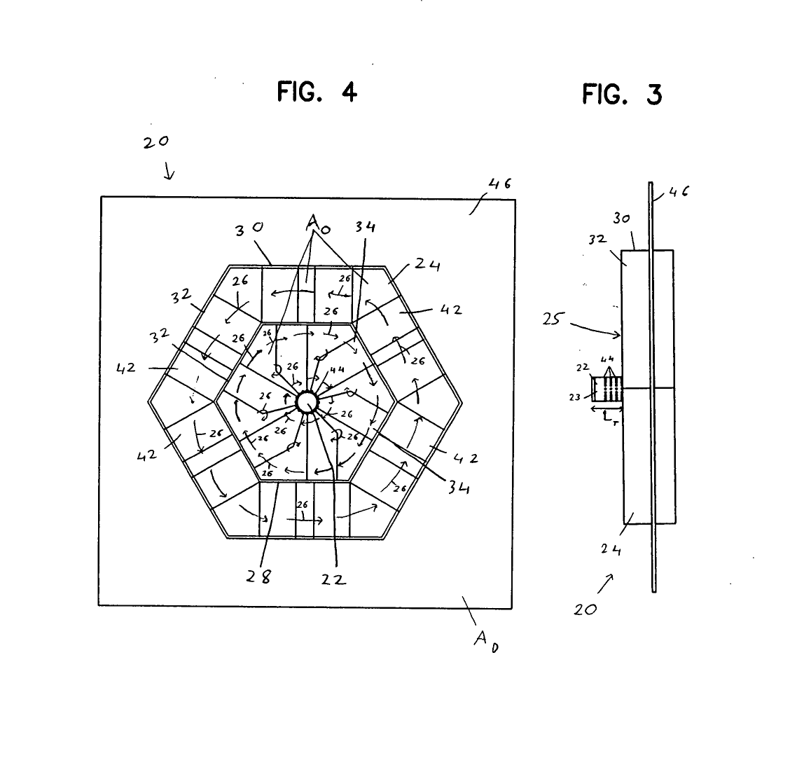

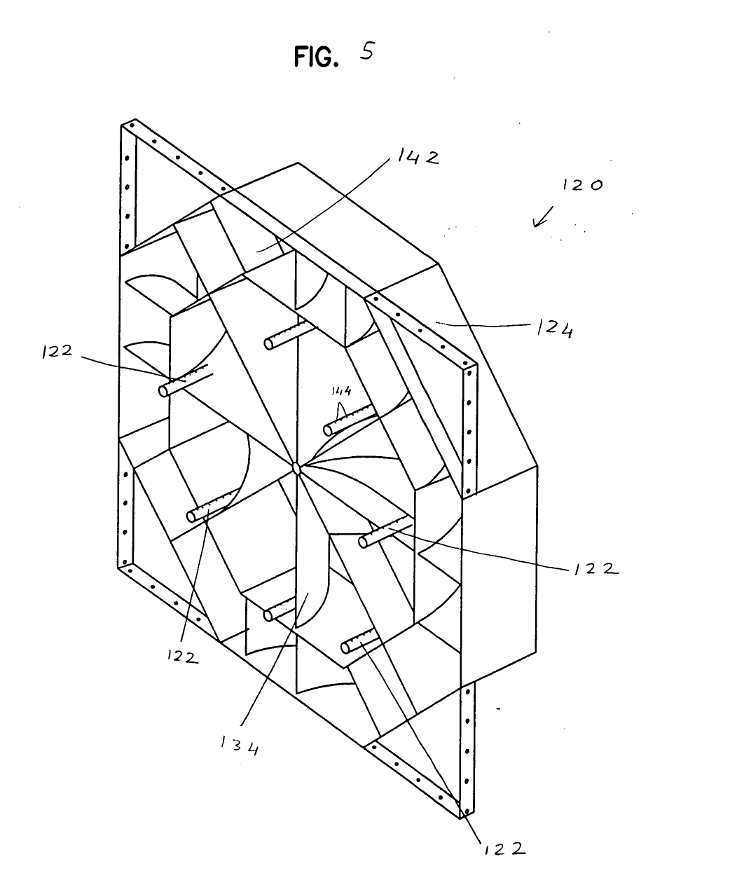

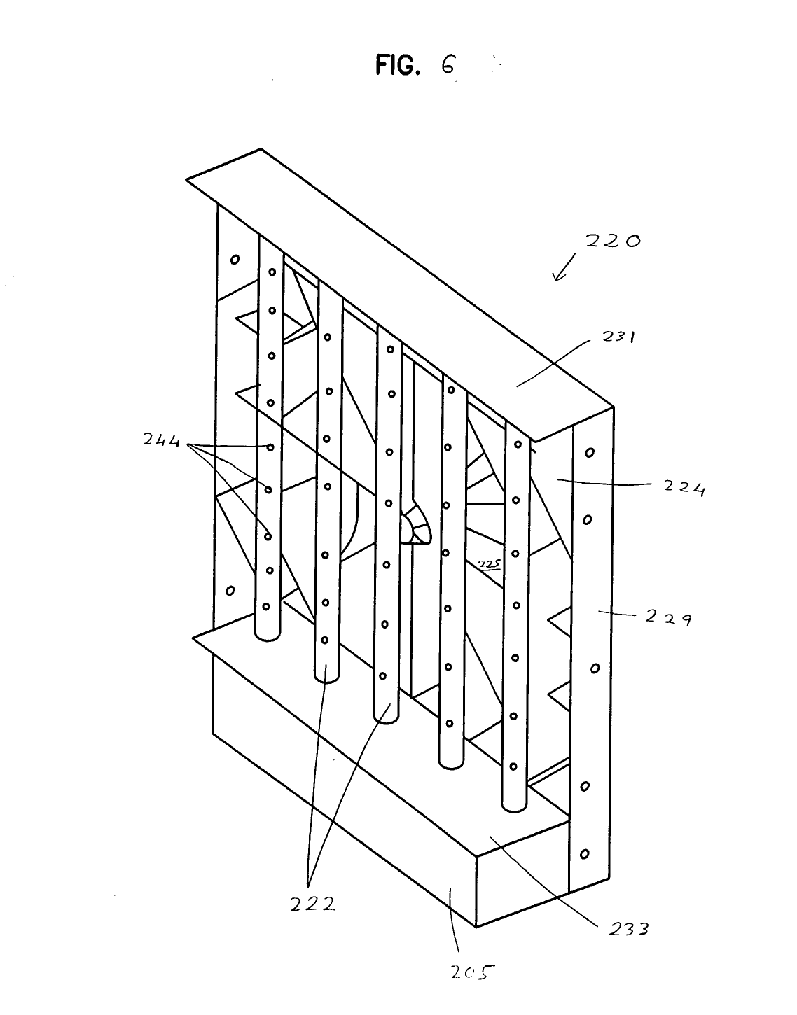

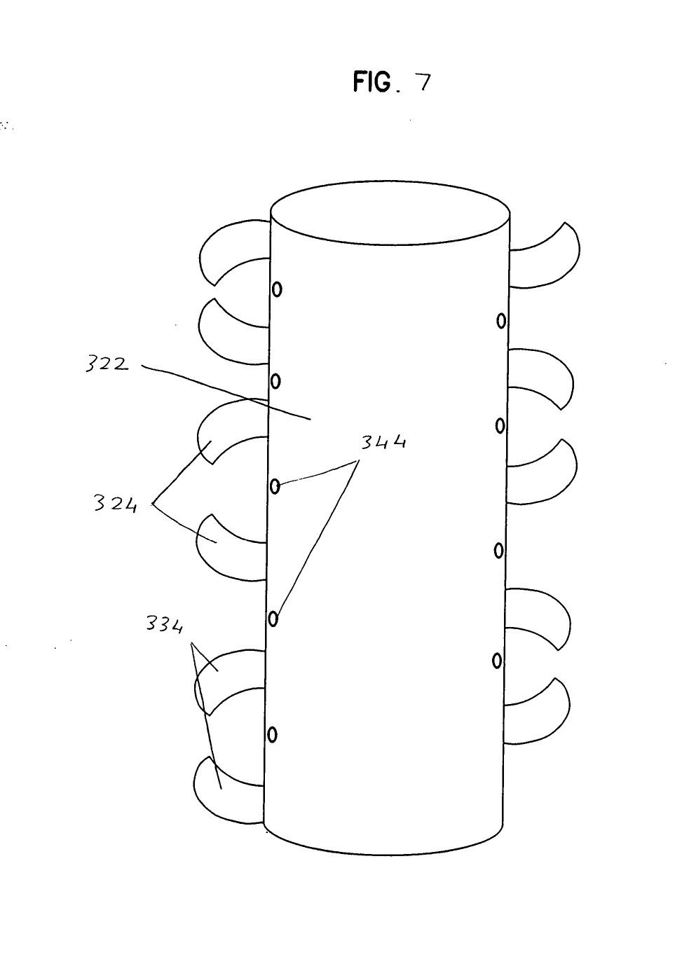

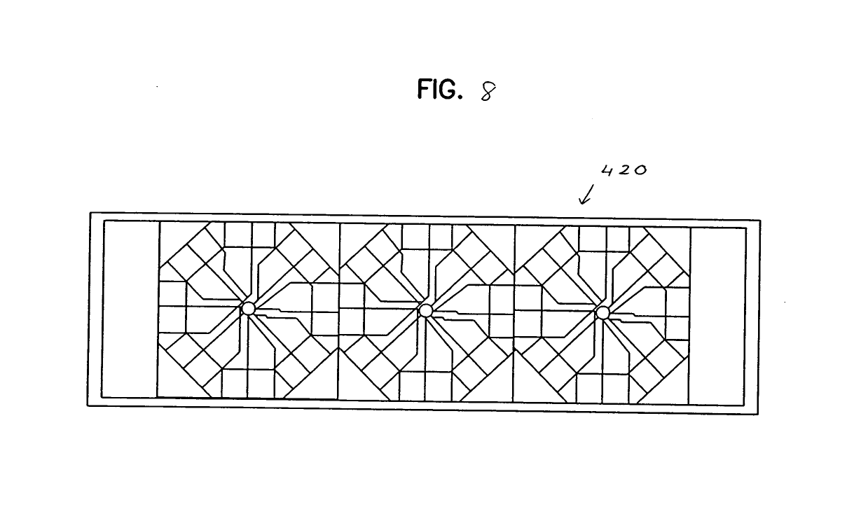

An embodiment of a steam dispersion apparatus having features that are examples of inventive aspects in accordance with the principles of the present disclosure is shown in FIGS. 1-4, designated generally at 20.

In FIG. 1, the steam dispersion apparatus 20 is shown positioned within an air duct 10. The air duct 10 may be part of a heating, ventilating and air conditioning (HVAC) system. In a conventional HVAC system, the air may be forced to flow through the air duct 10 by a fan. Arrows 12 represent the direction of airflow through the duct 10. The steam dispersion apparatus 20 may be placed within the duct 10 of the HVAC system for the purpose of humidifying the moving air.

Since configurations and operations of HVAC systems are well known in the art, further details thereof will not be provided herein, it being understood that those skilled in the art clearly understand the nature and variety of such systems. It should also be noted that the steam dispersion apparatus 20 may be used in a number of different environments, an HVAC system being one non-limiting example. As used herein, the term “steam” is defined as the invisible vapor into which water is converted to when heated to the boiling point of water. Another definition of “steam” as used herein is water in vapor phase.

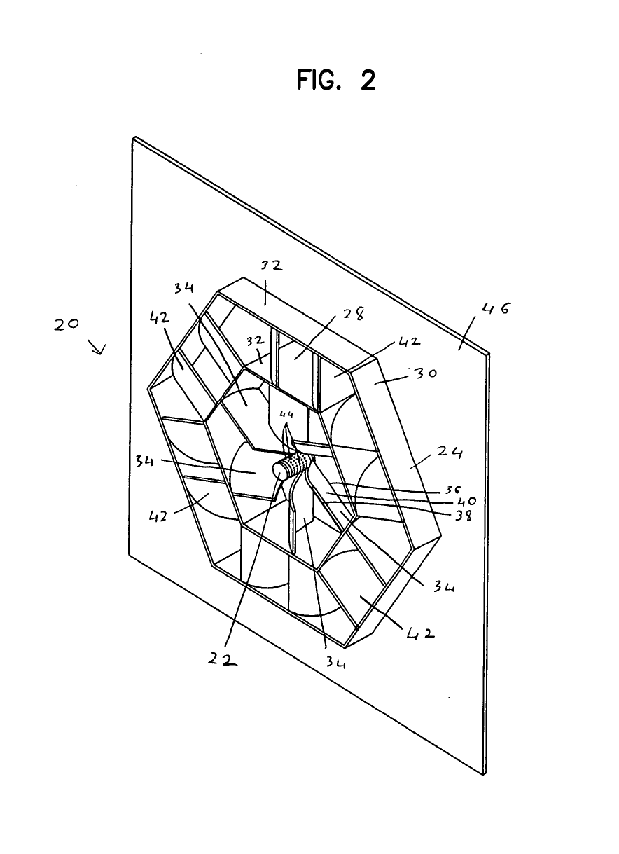

In FIGS. 2-4, the steam dispersion apparatus 20 is shown outside of the air duct 10. The steam dispersion apparatus 20 includes a steam tube 22 positioned in the center of a turbulence-inducing structure 24. In the depicted embodiment, the turbulence-inducing structure 24 is designed to cause air vortices 26 (see FIG. 4) in the moving air to maximize effective mixing without causing a significant drop in pressure. In other embodiments, other structures that can cause different air flow patterns may be used.

The turbulence-inducing structure 24 includes an inner frame 28 and a concentrically positioned outer frame 30. As shown in FIGS. 1-4, each of the inner and the outer frames 28, 30 includes a hexagonal shape formed by six rectangular panels 32 joined together. The panels 32 are preferably manufactured out of sheet metal. The panels 32 could also be made of plastic or other types of sheet type stock. The inner and outer frames 28, 30 can also include other shapes such as octagonal, circular or other polygonal shapes. A hexagonal or octagonal shape is preferred for rectangular ductwork installations.

A first plurality vanes 34 radially extend outwardly from the steam tube 22 and terminate at the panels 32 of the inner frame 28. Within the inner frame 28, there are provided six vanes 34, one corresponding to each panel 32 of the inner frame 28. However, it shall be understood that the number of vanes 34, just as in the number of panels 32, can be modified to provide the desired air mixing result. The vanes 34 within the inner frame 28 are uniformly spaced and are each curved in the same direction with respect to the air flow to impart either a clockwise or counterclockwise rotation to the air passing through the turbulence-inducing structure 24. Each of the first plurality of vanes 34 includes a leading edge 36, a trailing edge 38, and a curved portion 40 interconnecting the leading edge 36 to the trailing edge 38.

A second plurality of vanes 42 is located between the inner frame 28 and the outer frame 30. Each of the vanes 42 extends radially outwardly from the panels 32 of the inner frame 28 to the panels 32 of the outer frame 30. In the depicted embodiment, each side of the hexagon includes two vanes 42 extending between the inner frame 28 and the outer frame 30. Other numbers are contemplated. The vanes 42 of the second plurality have approximately the same cross-sectional shape as the first plurality of vanes 34. The second plurality of vanes 42, however, are curved with respect to the airflow in the duct 10, oppositely to the curvature of the first plurality of vanes 34 so as to impart an opposite directional rotation to the air passing by the second plurality of vanes 42. As a result, the particular vane arrangement provides the vortice patterns illustrated in FIG. 4, resulting in efficient mixing of airstreams at a downstream end 25 of the turbulence-inducing structure 24.

Although in FIGS. 1-4, the turbulence-inducing structure 24 is depicted as including vanes, in other embodiments, the turbulence-inducing structure 24 may include blades, baffles, etc. In one preferred embodiment, the turbulence-inducing structure 24 may be a static air mixer available from Blender Products, Inc., which is described in further detail in U.S. Pat. Nos. 6,878,056 and 5,645,481, the disclosures of which are incorporated herein by reference in their entirety. Another turbulence-inducing structure is disclosed in U.S. Pat. No. 4,495,858, the disclosure of which is incorporated herein by reference in its entirety.

FIG. 4 is a front elevational view of the steam dispersion apparatus 20 of the present invention, illustrating the turbulence-inducing structure 24 from a downstream end view. The directional arrows denote some of the various vortices 26 which are created by the two pluralities of vanes 34, 42 of the turbulence-inducing structure 24. For the purposes of this disclosure, vortices are those discrete air patterns which are created in the airstreams as the airstreams pass through the turbulence-inducing structure 24. As the air streams pass through the steam dispersion apparatus 20, the cross-sectional flow area is reduced from the cross-sectional area A_{D} of the duct 10 to the open area AO defined between the vanes. As the air streams pass through the steam dispersion apparatus 20, because of the reduction in the cross-sectional flow area, the velocity of the air increases. As the air streams move past the turbulence-inducing structure 24 and move farther downstream, the vortice patterns 26 become more divergent and the air streams obtain slower velocities. The steam dispersion tube 22, by being positioned at the immediate downstream end 25 of the turbulence-inducing structure 24, is, located at a preferred location for efficiently mixing the steam into the moving air.

Referring now to FIGS. 2-4, in the embodiment depicted, the steam tube 22 extends longitudinally along the center of the turbulence-inducing structure 24. In the depicted embodiment, the steam tube 22 of the steam dispersion apparatus 20 includes a plurality of radially arranged steam nozzles 44 for dispersing the steam radially outwardly from the steam tube 22. The steam nozzles 44 are located adjacent the downstream end 25 of the turbulence-inducing structure 24, wherein steam is emitted into the created air vortices 26 to provide efficient absorption of the steam into the air stream and to provide for shorter absorption distances. The nozzles 44 emit steam in a generally perpendicular direction to the direction of the air flow 12. Please see FIG. 1. In one embodiment, the steam tube 22 includes twenty-four radially arranged nozzles 44. Other sizes or numbers are certainly possible depending upon the desired humidification needs.

It should be understood that, although in the depicted embodiment, the nozzles 44 are arranged radially around the steam tube 22 and emit steam in a generally perpendicular direction to the airflow 12, in other embodiments, the steam nozzles 44 may be configured such that they emit steam into the airflow 12 at angles of less than 90 degrees. In yet certain other embodiments, the nozzles 44 or a single nozzle 44 can be placed axially at the downstream end of the steam tube 22 and emit steam in a direction generally parallel to the direction of the airflow 12.

The nozzles 44 are preferably spaced evenly around a perimeter 23 of the steam tube 22. The nozzles 44 may be affixed in the steam tube 22 by any conventional means. Although the nozzles 44 in the depicted embodiment are configured to cover generally a majority of the surface area of the steam tube, in other embodiments, the nozzles 44 may be located at discrete locations or at a single location, such as the downstream end of the steam tube 22. In such an embodiment, the steam tube 22 may still extend longitudinally from the center of the turbulence-inducing structure 24 and carry the steam therewithin until the steam exits out of the nozzles, which may be axially positioned or radially positioned along the steam tube 22.

In one preferred embodiment, the steam tube 22 is between about 4 inches and 12 inches in length L_{T}. More preferably, the steam tube 22 is between about 6 inches and 9 inches in length L_{T}. Most preferably, the steam tube 22 is about 7 inches in length L_{T}.

It should be noted, however, that the length of the steam tube 22 can vary depending upon the width W_{D} and height H_{D} of the duct 10. The larger the cross-sectional area A_{D} of the duct 10, the longer the steam tube 22 can be. In an embodiment wherein the nozzles 44 are not provided along a majority of the length of the steam tube 22, the larger the cross-sectional area A_{D} of the duct 10, the farther down along the steam tube 22 the steam nozzles 44 can be located. For example, in an embodiment wherein the duct has a height H_{D} of 2 feet and width W_{D} of 2 feet, the length L_{T} of the steam tube 22 can go up to 2 feet or the location of the steam nozzles 44 can be up to 2 feet from the turbulence inducing structure 24. In another embodiment wherein the duct has a height H_{D} of 6 feet and width W_{D} of 6 feet, the length L_{T} of the steam tube 22 can go up to 6 feet or the location of the steam nozzles 44 can be up to 6 feet from the turbulence inducing structure 24.

In one preferred embodiment, the steam tube 22 is between about 0.5 and 4.5 inches in diameter. More preferably, the steam tube 22 is between about 1 and 3.5 inches in diameter. Most preferably, the steam tube 22 is about 3 inches in diameter.

The steam in the steam tube 22 may be supplied by conventional means, e.g., a boiler (not shown). In the depicted embodiment, the steam is received under pressure from the boiler and is forced radially outwardly through the steam nozzles 44. In other embodiments, the velocity or the amount of the steam may be regulated via certain control mechanisms based on certain variables. In certain embodiments, devices such as pressure regulators, valves, humidistat, thermostats, etc., may be used to regulate the amount or velocity of the steam based on certain variables.

Still referring to FIGS. 1-4, the steam dispersion apparatus 20 includes a mounting flange 46 surrounding the turbulence-inducing structure 24. The mounting flange 46 may be used to mount the steam dispersion apparatus 20 to the walls 11 of the air duct 10. The mounting flange 46 is also used to seal the duct 10 such that air streams are forced to go through the turbulence-inducing structure 24. The mounting flange 46 may be shaped and sized according to the cross-section of the duct 10. The steam dispersion apparatus 24 may be mounted to the walls 11 of the duct 10 by any means generally known in the art, e.g., fasteners, welding, etc.

In operation, when the blown air flows through the turbulence-inducing structure 24, the inner and outer vanes 34, 42 deflect the flowing air and cause counter rotating air vortices 26, respectively. As the air flows through the vanes 34, 42, because of the reduction in the cross-sectional flow area, the velocity of the air increases. The steam supplied via a conventional boiler exits the steam tube 22 through the nozzles 44 at the downstream end 25 of the turbulence-inducing apparatus 24. Due to the increased velocity of the air through the steam-inducing structure 24 and the changes in the flow characteristics of the air adjacent the steam nozzles 44, steam is more efficiently dispersed into the air in the duct 10. The more air per unit of time that can be moved past each nozzle 44, the greater amount of steam that can be absorbed within a given distance.

In one experimental test, an embodiment of the steam dispersion apparatus that used a steam tube with a 7-inch length and a 3-inch diameter and having twenty-four radially arranged nozzles in combination with a steam-inducing structure provided a shorter absorption distance and 80% less condensate and heat gain than a steam dispersion unit using sixteen 3-inch center-to-center tubes, each one being 34 inches long and 1.5 inches in diameter, with a total of six hundred and sixty nozzles, keeping all the other variables the same.

The turbulence caused by a structure such as the steam-inducing structure 24 allows the reduction of the number of tubes and the condensate within the system. Without the use of turbulence, short non-wetting or absorption distances may be accomplished by forcing steam into contact with air using a large number (hundreds to thousands) of steam discharge points. With turbulence, short non-wetting or absorption distances may be accomplished with a reduced number of steam discharge points.

It should be noted that, although in FIGS. 1-4, only a single steam dispersion apparatus is shown to be mounted within an air duct, in other embodiments, a plurality of the steam dispersion apparatuses with a plurality of turbulence-inducing structures and steam tubes can be used within an air duct (please see FIG. 8, for example). Such apparatuses can be sized and shaped accordingly to cover the cross-section of a particular duct.

Another embodiment of a steam dispersion apparatus having features that are examples of inventive aspects in accordance with the principles of the present disclosure is shown in FIG. 5, designated generally at 120. The steam dispersion apparatus 120 depicted in FIG. 5 is similar to the steam dispersion apparatus 20 of FIGS. 1-4, except that it includes a plurality of steam dispersion tubes 122 located on the turbulence inducing structure 124. The steam tubes 122 are shown as being positioned between the first plurality of vanes 134 and the second plurality of vanes 142. Each steam tube 122 may include any combination of the features discussed with respect to steam tube 22 of FIGS. 1-4. The steam nozzles 144 may be located at a variety of different locations around each steam dispersion tube 122.

The turbulence-inducing structure 124 may be similar to the turbulence-inducing structure 24 of FIGS. 1-4 and may have any of the characteristics discussed with respect thereto. For example, although the turbulence-inducing structure 124 is depicted as including vanes, in other embodiments, it may include blades, baffles, etc. The turbulence-inducing structure 124 may also include shapes other than which is disclosed in FIG. 5.

Referring to FIG. 6, there is illustrated another embodiment of a steam dispersion apparatus having features that are examples of inventive aspects in accordance with the principles of the present disclosure, designated generally at 220. In the embodiment of the steam dispersion apparatus 220, a plurality of steam tubes 222 are provided generally across the turbulence-inducing structure 224, rather than along a direction of the airflow as depicted in FIGS. 1-5. As shown in FIG. 6, the tubes are positioned at a downstream location 225 of a turbulence-inducing structure 224. Each steam tube 222 includes a plurality of steam nozzles 244 that discharge steam at a generally perpendicular direction to the direction of the airflow. It should be noted that the positioning of the steam nozzles 244 and the number of nozzles 244 can be changed according to desired mixing results.

Still referring to FIG. 6, although the steam tubes 222 are depicted as extending vertically in front of the turbulence-inducing structure 224, they can also be arranged horizontally across the duct 10. In other embodiments, the tubes 222 may be arranged at other angles relative to the turbulence-inducing structure 224.

The number of steam tubes 222, and, as discussed above, the number of steam dispersion nozzles 244 may certainly be changed. For example, in one embodiment, there may be a single, larger, steam dispersion tube 222 that extends in front of the turbulence-inducing structure 224, at any angle relative to the turbulence-inducing structure 224, instead of a plurality of tubes.

In the embodiment of the steam dispersion apparatus 220 shown in FIG. 6, the steam dispersion tubes 222 are depicted as being integrally formed with the turbulence-inducing structure 224. The turbulence-inducing structure 224 includes a mounting frame 229 that includes forwardly-extending flanges 231, 233, at top and bottom sides, respectively, of the frame 229. The flanges 231, 233 support and position the steam dispersion tubes 222 at the downstream end 225 of the turbulence-inducing structure 224. In the depicted embodiment, the dispersion tubes 222 extend from a steam header 205. In other embodiments, the tubes 222 may be provided separately from the turbulence-inducing structure 224 and may be supported in their own frame structure.

In FIG. 7, yet another embodiment of a steam dispersion apparatus having features that are examples of inventive concepts in accordance with the disclosure is shown. The embodiment shown in FIG. 7 includes a steam tube 322 with a plurality of turbulence-inducing structures 324 directly attached thereto. In certain embodiments, the turbulence-inducing structures 324 may be formed integrally with the steam tubes 322. In FIG. 7, the turbulence-inducing structures 324 are depicted as vanes 334 that are formed integrally with the tube 322, but may be other structures such as blades, baffles, etc. In certain other embodiments, the turbulence-inducing structures may be attached to the steam tube 322 by any means known in the art such by welding, with fasteners, etc.

In the embodiment of FIG. 7, the turbulence-inducing structures 324 are positioned between the steam nozzles 344. The turbulence-inducing structures 324 may induce multiple vortices into which steam is mixed, reducing the non-wetting or the absorption distance. A steam tube such as the tube 322 shown in FIG. 7 may be used with or without an additional turbulence-inducing structure such as the one shown in FIGS. 1-6. In a steam dispersion system, one such steam dispersion tube 322 or a plurality of the steam dispersion tubes 322 may be used depending upon the desired mixing characteristics.

As a further variation of the embodiment of FIG. 7, turbulence-inducing structures may be attached directly to or formed integrally with the walls of the air duct 10.

FIG. 8 illustrates yet another embodiment of a steam dispersion apparatus 420 having features that are examples of inventive concepts in accordance with the disclosure. The embodiment of FIG. 8 generally includes a plurality of the steam dispersion apparatuses shown in FIGS. 1-4 in a stacked arrangement. The number of the steam dispersion apparatuses and the arrangement can certainly vary depending upon the shape and the size of the duct. Each steam dispersion apparatus that makes up the embodiment of FIG. 8 may have any combination of the features discussed above with respect to those embodiments discussed with reference to FIGS. 1-7, such as single or multiple steam dispersion tubes, angled at a variety of different angles, with single or multiple steam discharge nozzles arranged in various positions around the steam dispersion tubes, etc.

The above specification, examples and data provide a complete description of the disclosure. Many embodiments of the inventive aspects can be made without departing from the spirit and scope of the disclosure.

1. A steam dispersion apparatus configured to humidify a flow of air passing by the steam dispersion apparatus, the steam dispersion apparatus comprising:
a steam dispersion tube configured to emit water in a vapor phase, the steam dispersion tube including a longitudinal axis, the longitudinal axis extending generally parallel to the direction of air flow passing by the steam dispersion apparatus, the steam dispersion tube including a steam exit; and
a turbulence inducing structure located upstream of the steam dispersion tube with respect to the air flow, the turbulence inducing structure configured to increase the velocity of the air that passes through the turbulence inducing structure.

2. A steam dispersion apparatus according to claim 1, wherein the turbulence inducing structure includes a plurality of vanes that extend in a direction generally radially outwardly from the steam dispersion tube.

3. A steam dispersion apparatus according to claim 1, wherein the steam dispersion tube is positioned generally along a center axis of the turbulence inducing structure.

4. A steam dispersion apparatus according to claim 1, further comprising a plurality of the steam dispersion tubes extending generally along the direction of the air flow, each steam dispersion tube located downstream from the turbulence inducing structure with respect to the air flow.

5. A steam dispersion apparatus according to claim 1, wherein the turbulence inducing structure is configured to impart either a clockwise or a counterclockwise rotation to the air passing through the turbulence inducing structure.

6. A steam dispersion apparatus according to claim 5, wherein the turbulence inducing structure includes a plurality of curved blades.

7. A steam dispersion apparatus according to claim 1, wherein the steam exit includes a plurality of nozzles disposed on the steam dispersion tube.

8. A steam dispersion apparatus according to claim 1, wherein the steam exit is configured to emit steam in a direction generally perpendicular to the direction of the air flow.

9. A steam dispersion apparatus according to claim 1, wherein the steam exit is disposed with respect to the steam dispersion tube such that the steam exit is configured to emit steam in a direction less than ninety degrees with respect to the direction of the air flow.

10. A steam dispersion apparatus according to claim 1, further comprising a plurality of the steam dispersion tubes extending generally along the direction of the air flow and a plurality of the turbulence inducing structures, each steam dispersion tube located downstream of each turbulence inducing structure with respect to the air flow.

11. A steam dispersion apparatus configured to humidify a flow of air passing by the steam dispersion apparatus, the steam dispersion apparatus comprising:
a steam dispersion tube configured to emit water in a vapor phase, the steam dispersion tube including a longitudinal axis, the longitudinal axis extending generally non-parallel to the direction of air flow passing by the steam dispersion apparatus, the steam dispersion tube including a steam exit; and
a turbulence inducing structure located upstream of the steam dispersion tube with respect to the air flow, the turbulence inducing structure configured to impart either a clockwise or a counterclockwise rotation to the air passing through the turbulence inducing structure.

12. A steam dispersion apparatus according to claim 11, wherein the longitudinal axis of the steam dispersion tube extends generally perpendicular to the direction of the air flow.

13. A steam dispersion apparatus according to claim 11, further comprising a plurality of the steam dispersion tubes extending generally non-parallel to the direction of the air flow, each steam dispersion tube located downstream from the turbulence inducing structure with respect to the air flow.

14. A steam dispersion apparatus according to claim 11, wherein the steam exit includes a plurality of nozzles disposed on the steam dispersion tube.

15. A steam dispersion apparatus according to claim 11, wherein the steam exit is configured to emit steam in a direction generally perpendicular to the direction of the air flow.

16. A steam dispersion apparatus according to claim 11, wherein the turbulence inducing structure includes a plurality of curved blades.

17. A method of humidifying at least a segment of air flow, comprising:
(i) providing a steam dispersion tube configured to emit water in a vapor phase, the steam dispersion tube including a longitudinal axis, the longitudinal axis extending generally parallel to the direction of the air flow;
(ii) providing a turbulence inducing structure upstream from the steam dispersion tube with respect to the air flow, the turbulence inducing structure configured to increase a velocity of the air flow that passes through the turbulence inducing structure; and
(iii) providing air through the turbulence inducing structure and passing the air by the steam dispersion tube.

18. A method according to claim 17, further comprising providing a plurality of the steam dispersion tubes extending generally along the direction of the air flow, each steam dispersion tube located downstream of the turbulence inducing structure with respect to the air flow.

19. A method according to claim 17, further comprising emitting steam in a direction generally perpendicular to the direction of the air flow.

20. A method according to claim 17, further comprising imparting either a clockwise or a counterclockwise rotation to the air flow passing through the turbulence inducing structure.
